(19) United States
(12) Patent Application Publication
(10) Pub. No.: US 2019/0345616 A1
(43) Pub. Date: Nov. 14, 2019

(54) METHOD OF AND SYSTEM FOR MONITORING A CORROSION OF A DEVICE IN REAL-TIME

(71) Applicant: GM Global Technology Operations LLC, Detroit, MI (US)

(72) Inventors: Surender Maddela, Rochester Hills, MI (US); Hua-Tzu Fan, Troy, MI (US); Azeem Sarwar, Rochester Hills, MI (US); Andrew C. Bobel, Clinton Twp., MI (US); Jason Prince, Frazer, MI (US); Hongliang Wang, Sterling Heights, MI (US); Venkateshwar R. Aitharaju, Troy, MI (US)

(73) Assignee: GM Global Technology Operations LLC, Detroit, MI (US)

(21) Appl. No.: 15/978,604

(22) Filed: May 14, 2018

(51) Int. Cl. C23F 13/22; G01N 27/416; G01N 27/20; G01N 27/24

(52) U.S. Cl. CPC C23F 13/22; G01N 27/24; G01N 27/20; G01N 27/416

(57) ABSTRACT

A method monitoring a corrosion of a device includes conveying an electrical current through a monitoring component. The monitoring component includes a replaceable consumable electrode embedded in an electrolyte and disposed onboard and in electrical communication with the device. The electrode is configured to degrade before the device corrodes. The monitoring component includes a sensor disposed in electrical communication with the replaceable consumable electrode and the device. The sensor is configured for detecting a degradation of the electrode. After conveying, the method includes sending a first signal from the sensor to a storage medium. After sending the first signal, the method includes sending a second signal from the storage medium to a communication device to thereby monitor the corrosion. A monitoring system and a method of monitoring a corrosion of a plurality of joints of the device are also described.

### INTRODUCTION

The disclosure relates to a method of and monitoring system for monitoring a corrosion of a device.

Corrosion is a process which gradually degrades or deteriorates a material, such as a metal, by chemical and/or electrochemical reaction between the material and an ambient environment. In particular, corrosion degrades a surface of the material by converting the surface into a comparatively more stable form, e.g., an oxide, hydroxide, or sulfide of the material.

### SUMMARY

A method of monitoring a corrosion of a device includes conveying an electrical current through a monitoring component. The monitoring component includes a replaceable consumable electrode embedded in an electrolyte and disposed onboard and in electrical communication with the device. The replaceable consumable electrode is configured to degrade before the device corrodes. The monitoring component also includes a sensor disposed in electrical communication with the replaceable consumable electrode and the device. The sensor is configured for detecting a degradation of the replaceable consumable electrode. After conveying the electrical current, the method includes sending a first signal from the sensor to a storage medium. After sending the first signal, the method includes sending a second signal from the storage medium to a communication device to thereby monitor the corrosion.

Further, sending the second signal may include continuously transmitting the second signal to the communication device in real-time.

In one aspect, the method may further include continuously measuring the electrical current conveyed through the replaceable consumable electrode to provide a collected electrical current. The method may further include, after continuously measuring, adjusting the collected electrical current to provide a filtered current. After adjusting, the method may include calculating a corrosion rate based on the filtered current and comparing the corrosion rate to a threshold corrosion rate.

After adjusting, the method may include accumulating the filtered current. Further, after accumulating, the method may include estimating a loss of mass of the replaceable consumable electrode, determining a remaining mass of the replaceable consumable electrode, and comparing the remaining mass to a threshold mass.

A monitoring system for monitoring a corrosion of a device includes a monitoring component. The monitoring component includes a replaceable consumable electrode embedded in an electrolyte and disposable onboard and in electrical communication with the device. The replaceable consumable electrode is configured to degrade before the device corrodes. The monitoring component also includes a sensor disposed in electrical communication with the replaceable consumable electrode and configured for detecting a degradation of the replaceable consumable electrode. The monitoring system further includes a storage medium disposed in wireless communication or electrical communication with the replaceable consumable electrode and configured for receiving a first signal from the sensor. In addition, the monitoring system includes a communication device disposed in wireless communication or electrical communication with the storage medium and configured for receiving a second signal from the storage medium.

In one aspect, the electrolyte may be a solid electrolyte or a liquid electrolyte.

Further, the communication device may be at least one of a vehicle dashboard, a cellular telephone, and an internet-based communication system.

In another aspect, the replaceable consumable electrode may be configured to decrease in mass as the replaceable consumable electrode degrades.

In an additional aspect, the monitoring system may further include a plurality of replaceable consumable electrodes each configured to degrade at different rates before the device corrodes.

In another embodiment, a method of monitoring a corrosion of a plurality of joints of a device includes detecting a change in an electrical property of at least one of the plurality of joints with a monitor that is disposed in electrical communication with each pair of the plurality of joints. Detecting includes measuring an initial electrical property and a final electrical property between each pair of the plurality of joints, and determining a difference between the initial electrical property and the final electrical property to thereby provide a computed electrical property. The method further includes comparing the computed electrical property to a threshold electrical property to provide an alert value. After comparing, the method includes sending a first signal from the device to a storage medium. After sending the first signal, the method includes sending a second signal from the storage medium to a communication device to thereby monitor the corrosion.

In one aspect, measuring the initial electrical property may include calculating: an average initial resistance or an average initial capacitance; and a standard deviation of the initial resistance or a standard deviation of the initial capacitance, respectively. Further, measuring the final electrical property may include calculating: an average final resistance or an average final capacitance; and a standard deviation of the final resistance or a standard deviation of the final capacitance, respectively.

Determining may include calculating a first difference between the average final resistance and the average initial resistance; or a second difference between the average final capacitance and the average initial capacitance; and a first ratio between the first difference and a pooled standard deviation of the final resistance; or a second ratio between the second difference and a pooled standard deviation of the final capacitance.

In one aspect, comparing may include identifying a location of the corrosion on the device. In another aspect, comparing may include recording the alert value in a reference two-dimensional array. Further, recording may include color coding the reference two-dimensional array according to whether the corrosion is occurring at each of the plurality of joints.

In one aspect, the method may further include forming at least one of the plurality of joints from dissimilar materials. In another aspect, the method may further include forming at least one of the plurality of joints by at least one of welding, adhering, melting, and mechanically fastening.

### BRIEF DESCRIPTION OF THE DRAWINGS

FIG. 1. is a schematic illustration of a side view of a monitoring system for measuring a corrosion of a device.

FIG. 2 is a flowchart of a method of monitoring the corrosion of the device of FIG. 1.

FIG. 3 is a flowchart of a method of monitoring a corrosion of a plurality of joints of the device of FIG. 1.

FIG. 4 is a schematic illustration of a side view of a plurality of joints of the device of FIG. 1 correlated to a reference two-dimensional array coded according to whether corrosion is occurring at each of the plurality of joints.

### DETAILED DESCRIPTION

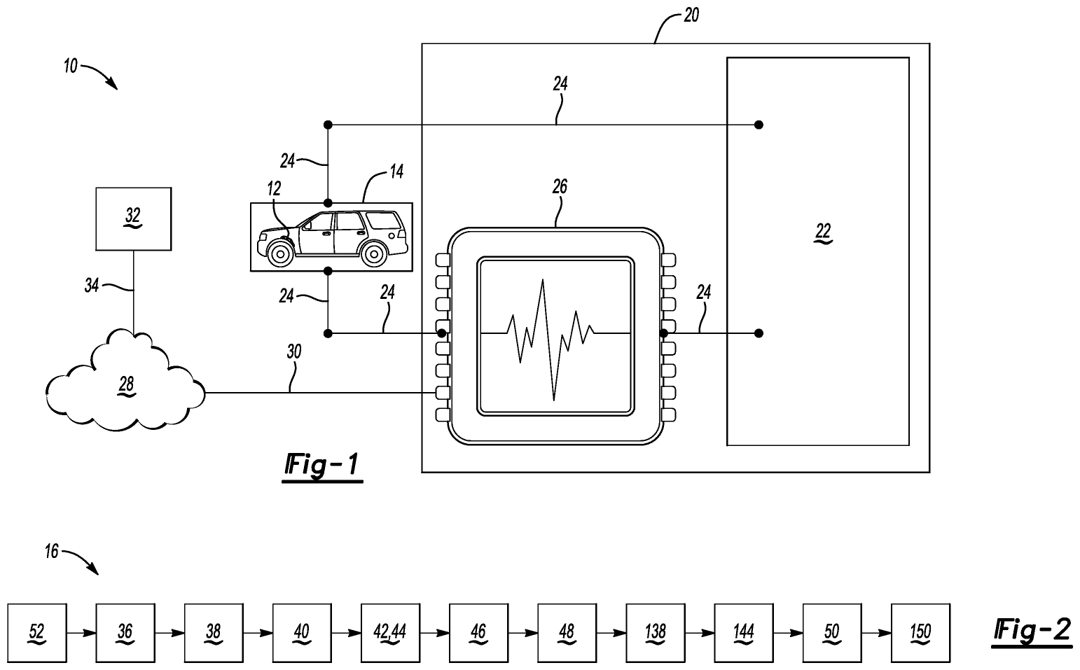

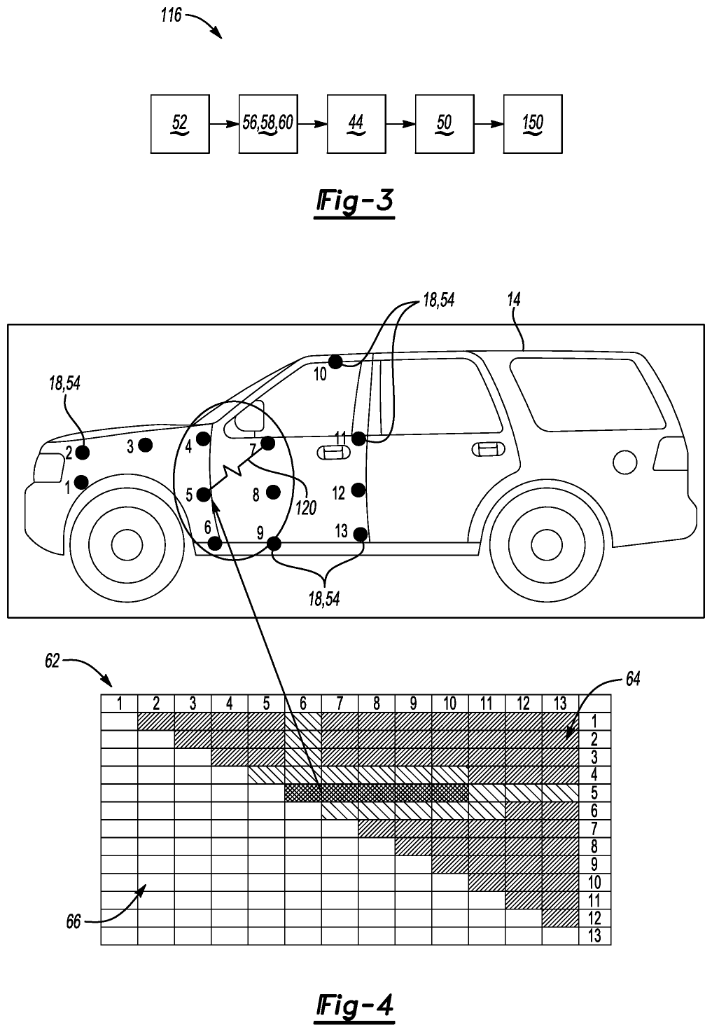

Referring to the Figures, wherein like reference numerals refer to like elements, a monitoring system 10 for measuring a corrosion 12 of a device 14 is shown generally in FIG. 1. Further, a method 16 of monitoring the corrosion 12 of the device 14 is shown generally in FIG. 2, and a method 116 of monitoring the corrosion 12 of a plurality of joints 18 (FIG. 4) of the device 14 is shown generally in FIG. 3. In particular, the monitoring system 10 and methods 16, 116 may be useful for applications and devices 14 that are susceptible to corrosion 12. That is, the monitoring system 10 may be useful for surveilling or electronically inspecting the device 14 to detect corrosion 12 in real-time, i.e., virtually immediately, which may avoid costly and time-consuming visual inspection or teardown of the device 14.

As such, the monitoring system 10 and methods 16, 116 may be useful for automotive, aerospace, and industrial vehicular applications such as, but not limited to, automobiles, airplanes, rockets, trains, trams, farming equipment, earthmoving equipment, mining equipment, and boats. Alternatively, the monitoring system 10 and methods 16, 116 may be useful for non-vehicular applications including, but not limited to, pipelines such as oil, gas, or other fluid conveyance systems; infrastructure applications such as bridges and roadways; support structure applications such as electrical transmission towers and fluid storage tanks; and the like. More specifically, in one non-limiting embodiment, the device 14 may be a vehicle and the monitoring system 10 and methods 16, 116 may be useful for automotive applications in which a vehicle user, dealer, and/or manufacturer may receive notifications of potential impending corrosion 12 or corrosion 12 that is already present on the vehicle.

As described in further detail below, the monitoring system 10 and methods 16, 116 monitor the device 14 for corrosion 12 in real-time, notify a party that the device 14 requires additional or continued corrosion protection or inspection, and may therefore protect the device 14 from further corrosion 12. As such, the monitoring system 10 and methods 16, 116 are cost-effective and simple and may eliminate costly visual inspection, teardown of the device 14, and/or replacement of corroded portions of the device 14. The monitoring system 10 and methods 16, 116 may efficiently detect early stages of corrosion 12 that may be otherwise difficult to detect before becoming advanced. Further, without the monitoring system 10, one or more unmonitored components of the device 14 may require continuous visual inspection. Alternatively, without the monitoring system 10, a continuous electrical current impressed onto the device 14 may decrease an operating life of the device 14 and may enhance corrosion 12 under specific conditions.

Referring again to FIG. 1, the monitoring system 10 includes a monitoring component 20 that may be configured for electronically inspecting the device 14 to thereby monitor any corrosion 12 of the device 14. The monitoring component 20 may be a single, easily-replaceable, packaged piece that may be installed onto the device 14 for corrosion monitoring.

More specifically, as illustrated generally in FIG. 1, the monitoring component 20 includes a replaceable consumable electrode 22 disposable onboard and in electrical communication with the device 14. The replaceable consumable electrode 22 may be a battery or anode disposed in physical contact with the device 14, and may be configured in an electrical circuit with the device 14, i.e., may be configured to convey an electrical current 24 to and from the device 14. In the case of a vehicle embodiment, the replaceable consumable electrode 22 may be disposed onboard the vehicle and may communicate with, for example, a battery, an engine control unit, or a central processing unit of the vehicle.

In addition, the replaceable consumable electrode 22 is configured to degrade before the device 14 corrodes. As such, the replaceable consumable electrode 22 may be characterized as consumable or sacrificial and may be replaced or substituted within the device 14 or monitoring component 20 after the replaceable consumable electrode 22 sufficiently degrades or deteriorates. That is, the replaceable consumable electrode 22 may corrode or degrade first, i.e., prior to corrosion of the device 14. More specifically, the replaceable consumable electrode 22 may be configured to decrease in mass as the replaceable consumable electrode 22 degrades.

For instance, the device 14 may be formed from a first material, such as, a metal or composite, and the replaceable consumable electrode 22 may be formed from a second material that is comparatively more electrically active than the first material. For example, the replaceable consumable electrode 22 may be formed from a metal or metal alloy having a more negative electrochemical potential than the first material of the device 14. As such, the replaceable consumable electrode 22 may be consumed in place of the device 14 and may therefore protect the device 14.

By way of non-limiting examples, the second material may be a comparatively active pure metal, such as zinc or magnesium, or may be a magnesium alloy or an aluminum alloy. During operation, the replaceable consumable electrode 22 may introduce a comparatively more electronegative and anodic surface to the device 14. As such, the electrical current 24 may flow from the replaceable consumable electrode 22 or anode to the second material of the device 14 such that the device 14 becomes cathodic and completes a galvanic cell between the replaceable consumable electrode 22 and the device 14. Any corrosion or oxidation reactions may therefore transfer from the device 14 to the replaceable consumable electrode 22 so that the replaceable consumable electrode 22 corrodes, degrades, or deteriorates instead of the protected device 14.

Therefore, the replaceable consumable electrode 22 may include a consumable anode and may be embedded in an electrolyte (not shown), e.g., a solid electrolyte or a liquid electrolyte. Suitable non-limiting examples of solid electrolytes may include doped zirconium oxide, silver iodide, aluminum oxide, calcium difluoride, lithium lanthanum titanate, lithium aluminum titanium phosphate, lithium phosphorus sulfide, lithium tin phosphorus sulfide, and the like. Suitable non-limiting examples of liquid electrolytes may include ammonium-based ionic liquids, imidazolium-based ionic liquids, pyrrolidinium-based ionic liquids, piperidinium-based ionic liquids, pyrazolium-based ionic liquids, and the like.

As described with continued reference to FIG. 1, the monitoring component 20 further includes a sensor 26 disposed in electrical communication with the replaceable consumable electrode 22 and the device 14 and configured for detecting a degradation of the replaceable consumable electrode 22. Therefore, as shown in FIG. 1, the sensor 26 may sense or detect the electrical current 24 flowing from the replaceable consumable electrode 22 to the device 14. Further, the sensor 26 may be configured for data collection and/or transmission via a wired or wireless connection to, for example, an onboard processing unit (not shown) of the device 14 and/or a storage medium 28, e.g., a cloud-based database, a read-only memory, and the like. The sensor 26 may be any suitable electrical sensor and may be, by way of non-limiting examples, a Hall effect sensor, a giant magnetoresistance sensor, a capacitor, or a resistor.

In addition, although not shown, the monitoring system 10 may include more than one monitoring component 20, more than one replaceable consumable electrode 22, and/or more than one sensor 26 according to the required corrosion protection of the device 14. For example, the monitoring system 10 may include a plurality of replaceable consumable electrodes 22 each configured to degrade at different rates before the device 14 corrodes. In one embodiment, the plurality of replaceable consumable electrodes 22 may be configured as one or more corrosion fuses that are configured to corrode or fail at different rates to further detect corrosion 12 or protect electronic equipment of the device 14 or monitoring system 10.

As described with continued reference to FIG. 1, the monitoring system 10 also includes the storage medium 28 disposed in wireless communication or electrical communication with the monitoring component 20 and configured for receiving a first signal (denoted generally at 30) from the sensor 26. The first signal 30 may be transmitted via wiring or wirelessly and may correspond to, for example, a resistance value or a capacitance value at a given time. The storage medium 28 may be any medium suitable for storing the first signal 30, such as, but not limited to, non-volatile memory, read only memory (ROM), random access memory (RAM), electrically-erasable programmable read only memory (EEPROM), internet-based memory such as “the cloud”, rewritable memory such as dynamic random access memory (DRAM) and static random access memory (SRAM), and the like. Non-volatile memory may include solid-state flash memory, or any other similar form of long-term, non-volatile memory that may be used to store program data and/or software application algorithms.

The monitoring system 10 may further include a processor (not shown) that may be digitally interconnected with the storage medium 28, may be configured to retrieve program data and software application algorithms from the storage medium 28, and may execute the algorithms. The processor may be embodied as one or more distinct data processing devices, each having one or more microcontrollers or central processing units (CPU), read only memory (ROM), random access memory (RAM), electrically-erasable programmable read only memory (EEPROM), a high-speed clock, input/output (I/O) circuitry, and/or any other circuitry that may be required to perform the functions described herein.

Further, although not shown, the monitoring system 10 may include one or more display devices (not shown) disposed in communication with the storage medium 28, device 14, and/or processor. The one or more display devices may include a liquid crystal display (LCD), a light emitting diode display (LED), an organic light emitting diode display (OLED), and/or any similar style display/monitor that may exist or that may be hereafter developed. The one or more display devices may receive a visual data stream from the processor and/or the storage medium 28, and may display the visual data stream to a user in a visual manner.

Referring again to FIG. 1, the monitoring system 10 further includes a communication device 32 disposed in wireless communication or electrical communication with the storage medium 28 and configured for receiving a second signal (denoted generally at 34) from the storage medium 28. The second signal 34 may correspond to an alert or a prompt-for-action to the user and may indicate that an undesired level or rate of corrosion 12 is occurring, has occurred, or is expected to occur within a predetermined time frame. The communication device 32 may be, by way of non-limiting examples, at least one of a vehicle dashboard, a cellular telephone, the display device, a computer, a vehicle audible chime, an internet-based communication or notification system, an application, and the like. As such, the second signal 34 may be transmitted via wire or wirelessly and may be conveyed over a wired or wireless communications network. The communication device 32 may present information regarding the state of corrosion 12 of the device 14 to a user, e.g., a consumer, an operator, an engineering group, a dealer, and/or a manufacturer. For example, for vehicle applications, the monitoring system 10 may convey a message to the user to service the vehicle and/or may provide historical and/or predictive data to a research and development center regarding the corrosion 12.

Referring now to FIG. 2, the method 16 of monitoring the corrosion 12 of the device 14 includes conveying 36 or passing the electrical current 24 through the monitoring component 20. As set forth above, the monitoring component 20 includes the replaceable consumable electrode 22 embedded in the electrolyte and disposed onboard and in electrical communication with the device 14; and the sensor 26 disposed in electrical communication with the replaceable consumable electrode 22 and the device 14. Conveying 36 may include passing or transmitting the electrical current 24 through the replaceable consumable electrode 22, the sensor 26, and the device 14 to thereby form an electrical circuit.

More specifically, as described with continued reference to FIG. 1, the method 16 may further include continuously measuring 38 the electrical current 24 conveyed through the replaceable consumable electrode 22 to provide a collected electrical current. For example, the electrical current 24 may be continuously measured and collected by the sensor 26 and may be stored and/or processed by the storage medium 28. Therefore, continuously measuring 38 may allow the monitoring system 10 to monitor and detect corrosion 12 in real-time, as set forth in more detail below.

With continued reference to FIG. 2, the method 16 may further include, after continuously measuring 38, adjusting 40 the collected electrical current to provide a filtered current. For example, adjusting 40 may include normalizing the electrical current 24 and/or filtering the electrical current 24 for noise to thereby provide the filtered current.

After adjusting 40, the method 16 may include calculating 42 a corrosion rate based on the filtered current. For example, calculating 42 may include consulting historic corrosion levels and/or rates for the device 14, average expected or predictive corrosion levels and/or rates for the device 14, operating conditions, e.g., time, temperature, relative humidity, weather conditions, atmospheric conditions, etc., of the device 14, and the like to determine the corrosion rate.

Further, the method 16 may include comparing 44 the corrosion rate to a threshold corrosion rate. The threshold corrosion rate may be predetermined, may be set according to past, present, or predicted operating conditions of the device 14, and may correspond to a level of corrosion that is undesired for the device 14. For example, the threshold corrosion rate may predict a level of corrosion 12 that may affect the aesthetics of the device 14. As such, if the corrosion rate exceeds the threshold corrosion rate, the method 16 may include alerting the user to the corrosion event.

Referring again to FIG. 2, the method 16 may further include, after adjusting 40 the electrical current 24 to provide the filtered current, accumulating 46 the filtered current. That is, the method 16 may include storing or collecting the filtered current in, for example, the storage medium 28 and/or the processor.

Further, the method 16 may include, after accumulating 46, estimating 48 a loss of mass of the replaceable consumable electrode 22. That is, as described above, a portion of the replaceable consumable electrode 22 may be degraded or deteriorated and result in a loss of mass of the replaceable consumable electrode 22. Estimating 48 may include comparing a known starting or installed mass of the replaceable consumable electrode 22 to an operating mass of the replaceable consumable electrode 22 to ascertain the loss of mass of the replaceable consumable electrode 22.

Therefore, after estimating 48, the method 16 may include determining 138 a remaining mass of the replaceable consumable electrode 22. Further, after determining 138, the method 16 may include comparing 144 the remaining mass to a threshold mass. The threshold mass may be predetermined, may be set according to past, present, or predicted operating conditions of the device 14, and may correspond to a level of corrosion 12 that is undesired for the device 14. For example, the threshold mass may predict a level of corrosion 12 that may affect the aesthetics of the device 14. As such, if the remaining mass is less than or equal to the threshold mass, the method 16 may include alerting the user to the corrosion event.

As described with continued reference to FIG. 2, the method 16 also includes, after conveying 36, sending 50 the first signal 30 (FIG. 1) from the sensor 26 to the storage medium 28. The first signal 30 may represent a sensed level or rate of pending or occurring corrosion 12 of the device 14 and may be conveyed to the storage medium 28 for storage or further processing.

After sending 50 the first signal 30, the method 16 includes sending 150 the second signal 34 from the storage medium 28 to the communication device 32 to thereby monitor the corrosion 12. More specifically, sending 150 the second signal 34 may include continuously transmitting the second signal 34 to the communication device 32 in real-time. That is, in one scenario, the method 16 or sensor 26 may detect a change in an electrical property of the device 14, e.g., a degradation of the replaceable consumable electrode 22, a deviation in the electrical current 24, etc., according to the algorithm and data set forth above. Consequently, the first signal 30 may transmit from the sensor 26 to the storage medium 28, and the second signal 34 may transmit from the storage medium 28 to the communication device 32. Then, the method 16 may include alerting a user that an undesired level or rate of corrosion 12 is occurring, has occurred, or is expected to occur within a predetermined time frame.

Alternatively or additionally, in another scenario, method 16 or sensor 26 may not detect degradation of the replaceable consumable electrode 22. Consequently, the first signal 30 may transmit from the sensor 26 to the storage medium 28, but the second signal 34 may not transmit from the storage medium 28 to the communication device 32. Then, the method 16 may include not alerting the user, but may instead include storing or accumulating 46 the filtered current for ongoing monitoring of any corrosion 12. Therefore, the method 16 and monitoring system 10 provide a real-time feedback loop that may continuously or periodically monitor and detect corrosion 12 without expensive and time-consuming visual inspection, disassembly of the device 14, and/or reliance upon subjective evaluation of the device 14.

Referring now to FIGS. 3 and 4, the method 116 of monitoring the corrosion 12 of the plurality of joints 18 of the device 14 may be useful for monitoring corrosion 12 across an entirety of the device 14, in particular for devices 14 formed from a plurality of joints 18 including similar or dissimilar materials. That is, the method 116 may detect corrosion 12 across one or more of the plurality of joints 18. More specifically, as set forth in more detail below, by comparing a difference between an initial electrical property of the device 14 and a final electrical property the device 14 at a periodic time interval, the method 116 may provide continuous monitoring of a corrosion status of the plurality of joints 18 in real-time over an entire lifespan of the device 14.

The method 116 may include forming 52 at least one of the plurality of joints 18 by at least one of welding, adhering, melting, and mechanically fastening. For example, one or more of the plurality of joints 18 may be characterized as a weld. Further, in one embodiment, the plurality of joints 18 may be formed from similar materials, e.g., may include a first substrate formed from aluminum and joined to a second substrate also formed from aluminum.

Alternatively, the method 116 may include forming 52 at least one of the plurality of joints 18 from dissimilar materials. That is, the plurality of joints 18 may include the first substrate formed from steel and joined to the second substrate formed from carbon fiber. In addition, one or more of the plurality of joints 18 may be formed from a different pair of materials than another one or more of the plurality of joints 18. That is, each of the plurality of joints 18 may not be formed from the same materials. Non-limiting examples of suitable materials for the first substrate and/or the second substrate may include aluminum, carbon fiber, steel, magnesium, plastic, metal alloys, composites, and the like.

As such, one or more of the plurality of joints 18 may be electrically conductive or electrically non-conductive, and the method 116 may include detecting 56 a change in an electrical property, e.g., a resistance or a capacitance, of at least one of the plurality of joints 18, as set forth in more detail below. Therefore, the monitoring system 10 and methods 16, 116 may be useful for monitoring and detecting 56 corrosion 12 for metal-to-metal substrates, metal-to-composite substrates, and composite-to-composite substrates.

As described with reference to FIG. 4, the method 116 may include selecting a plurality of measurement points 54 each corresponding to a respective one of the plurality of joints 18 of the device 14. For example, for vehicular applications, the plurality of measurement points 54 may correspond to various portions of a front quarter panel and driver side door of the vehicle, and the plurality of measurement points 54 and joints 18 may be electrically connected to a central electronic control unit of the vehicle. Similarly, although not shown, for oil pipeline applications, the plurality of measurement points 54 and/or joints 18 may correspond to various sections along a longitudinal axis and/or various points along a diameter of the oil pipeline.

Therefore, referring again to FIG. 3, the method 116 includes detecting 56 the change in the electrical property of at least one of the plurality of joints 18 with a monitor (denoted generally at 120 across an exemplary single pair 18 in FIG. 4) disposed in electrical communication with each pair of the plurality of joints 18. For example, the monitor may be a microohmeter configured for recording a resistance across each pair of joints 18. That is, the monitor 120 may be arranged to record a respective resistance across each pair of joints 18, rather than across only the exemplary single pair of joints 18 shown for purposes of illustration in FIG. 4. Alternatively, the monitor 120 may be configured for recording a capacitance of each pair of joints 18. That is, detecting 56 may include evaluating the capacitance or resistance of at least one of the plurality of joints 18. For example, for non-electrically-conducting joints 18, the method 116 may include detecting 56 a change in the capacitance of one or more joints 18. Alternatively, for electrically-conducting joints 18, the method 116 may include detecting 56 a change in the resistance across one or more joints 18.

More specifically, for the method 116, detecting 56 includes measuring 58 an initial electrical property, e.g., an initial resistance or an initial capacitance, and a final electrical property, e.g., a final resistance or a final capacitance, between each pair of the plurality of joints 18. For example, the final electrical property may correspond to a condition in which the device 14 has been exposed to corrosive conditions, e.g., humidity and salt, for a period of time, e.g., during operation. Therefore, as an example, for applications that include four joints 18, the method 116 includes measuring 58 the initial electrical property and the final electrical property for each of the following pairs of the plurality of joints 18: the joint 1/joint 2 pair; the joint 1/joint 3 pair; the joint 1/joint 4 pair; the joint 2/joint 3 pair; the joint 2/joint 4 pair; and the joint 3/joint 4 pair.

More specifically, measuring 58 the initial electrical property may include calculating: a) an average initial resistance or an average initial capacitance; and b) a standard deviation of the initial resistance or a standard deviation of the initial capacitance, respectively. In addition, measuring 58 the final electrical property may include calculating: c) an average final resistance or an average final capacitance; and d) a standard deviation of the final resistance or a standard deviation of the final capacitance, respectively.

That is, the method 116 may include measuring 58 multiple initial resistance values or multiple initial capacitance values and calculating a) the average of the multiple initial resistance values or the average of multiple initial capacitance values, respectively. For example, a) the average of multiple initial values for each pair of the plurality of joints 18 may be recorded in an upper portion of a first two-dimensional array (not shown).

Further, the method 116 may include calculating b) the standard deviation of the multiple initial resistance values or the standard deviation of the multiple initial capacitance values. For example, b) the standard deviation of the multiple initial values may be recorded in a lower portion of the first-two dimensional array.

Similarly, the method 116 may include measuring 58 multiple final resistance values or multiple final capacitance values and calculating c) the average of the multiple final resistance values or the average of the multiple final capacitance values, respectively. For example, c) the average of the multiple final values may be recorded in an upper portion of a second two-dimensional array (not shown).

Further, the method 116 may include calculating d) the standard deviation of the multiple final resistance values or the standard deviation of the multiple final capacitance values. For example, d) the standard deviation of the multiple final values may be recorded in a lower portion of the second two-dimensional array.

Further, measuring 58 includes determining 60 a difference between the initial electrical property and the final electrical property to thereby provide a computed electrical property, which may be recorded in a reference two-dimensional array 62 (FIG. 4).

More specifically, determining 60 may include calculating e) a first difference between the average final resistance and the average initial resistance; and f) a first ratio between: f1) the first difference; and f2) a pooled standard deviation of the final resistance to thereby provide the computed electrical property. Alternatively, determining 60 may include calculating g) a second difference between the average final capacitance and the average initial capacitance; and h) a second ratio between: h1) the second difference; and h2) a pooled standard deviation of the final capacitance to thereby provide the computed electrical property.

For example, as described with reference to FIG. 4, the first difference or the second difference may be recorded in an upper portion 64 of the reference two-dimensional array 62. Similarly, the first ratio or the second ratio may be recorded in a lower portion 66 of the reference two-dimensional array 62. Together, the upper portion 64 and the lower portion 66 may provide the computed electrical property.

Referring again to FIG. 3, the method 116 further includes comparing 44 the computed electrical property to a threshold electrical property to provide an alert level. More specifically, comparing 44 may include recording the alert value in the reference two-dimensional array 62. Further, recording may include color coding the reference two-dimensional array 62 according to whether the corrosion 12 is occurring at each of the plurality of measurement points 54.

For example, the threshold electrical property may be predetermined and may correspond to a condition or value at which corrosion 12 is occurring or likely will occur within a specified time period. The alert level may therefore be computed as the difference between the computed electrical property and the threshold electrical property, and may be recorded and color coded in the reference two-dimensional array 62. For instance, a non-corrosive condition may require no attention from the user and may be recorded as a green alert level in the reference two-dimensional array 62. Similarly, an approaching-corrosive condition may require a warning to the user and may be recorded as a yellow alert level in the reference two-dimensional array 62. Likewise, corrosion 12 may require an action and attention from the user and may be recorded as a red alert level in the reference two-dimensional array 62.

As such, the reference two-dimensional array 62 may provide a quick, visual summary of corrosion 12 of the device 14. Advantageously, comparing 44 may include identifying a location, i.e., one or more pair of the plurality of measurement points 54/joints 18, of the corrosion 12 of the device 14. That is, if, for example, as shown in FIG. 4, a fifth measurement point 54 is recorded as a red alert level, the method 116 may alert the user to attend to corrosion 12 at a fifth joint 18 and/or to examine nearby joints 18 of the device 14.

Therefore, the method 116 also includes, after comparing 44, sending 50 the first signal 30 from the device 14 to the storage medium 28. After sending 50 the first signal 30, the method 116 also includes sending 150 the second signal 34 from the storage medium 28 to the communication device 32 to thereby monitor the corrosion 12.

That is, in one scenario, the method 116 may detect the change in the electrical property according to the algorithm, data, and reference two-dimensional array 62 set forth above such that the first signal 30 transmits from the sensor 26 to the storage medium 28 and the second signal 34 transmits from the storage medium 28 to the communication device 32. Then, the method 116 includes alerting the user that an undesired level or rate of corrosion 12 is occurring, has occurred, or is expected to occur within a predetermined time frame.

Alternatively or additionally, in another scenario, the method 116 may detect the change in the electrical property such that the first signal 30 transmits from the sensor 26 to the storage medium 28, but the second signal 34 does not transmit from the storage medium 28 to the communication device 32. Then, the method 16 may include not alerting the user, but instead storing or accumulating 46 the alert level for ongoing monitoring of any corrosion 12. Therefore, the method 116 and monitoring system 10 provide a real-time feedback loop that may continuously or periodically monitor and detect corrosion 12 without expensive and time-consuming visual inspection, disassembly of the device 14, and/or reliance upon subjective evaluation of the device 14. More specifically, by comparing a difference between the initial electrical property and the final electrical property at a periodic time interval, the method 116 may provide continuous monitoring of a corrosion status of the plurality of joints 18 in real-time over an entire lifespan of the device 14.

While the best modes for carrying out the disclosure have been described in detail, those familiar with the art to which this disclosure relates will recognize various alternative designs and embodiments for practicing the disclosure within the scope of the appended claims.

What is claimed is:

1. A method of monitoring a corrosion of a device, the method comprising:
conveying an electrical current through a monitoring component, wherein the monitoring component includes:
a replaceable consumable electrode embedded in an electrolyte and disposed onboard and in electrical communication with the device, wherein the replaceable consumable electrode is configured to degrade before the device corrodes; and
a sensor disposed in electrical communication with the replaceable consumable electrode and the device, wherein the sensor is configured for detecting a degradation of the replaceable consumable electrode;
after conveying, sending a first signal from the sensor to a storage medium; and
after sending the first signal, sending a second signal from the storage medium to a communication device to thereby monitor the corrosion.

2. The method of claim 1, further including continuously measuring the electrical current conveyed through the replaceable consumable electrode to provide a collected electrical current.

3. The method of claim 2, further including, after continuously measuring, adjusting the collected electrical current to provide a filtered current.

4. The method of claim 3, further including, after adjusting, calculating a corrosion rate based on the filtered current and comparing the corrosion rate to a threshold corrosion rate.

5. The method of claim 3, further including, after adjusting, accumulating the filtered current.

6. The method of claim 5, further including, after accumulating, estimating a loss of mass of the replaceable consumable electrode, determining a remaining mass of the replaceable consumable electrode, and comparing the remaining mass to a threshold mass.

7. The method of claim 1, wherein sending the second signal includes continuously transmitting the second signal to the communication device in real-time.

8. A monitoring system for monitoring a corrosion of a device, the monitoring system comprising:
a monitoring component including:
a replaceable consumable electrode embedded in an electrolyte and disposable onboard and in electrical communication with the device, wherein the replaceable consumable electrode is configured to degrade before the device corrodes; and
a sensor disposed in electrical communication with the replaceable consumable electrode and configured for detecting a degradation of the replaceable consumable electrode;
a storage medium disposed in wireless communication or electrical communication with the monitoring component and configured for receiving a first signal from the sensor; and
a communication device disposed in wireless communication or electrical communication with the storage medium and configured for receiving a second signal from the storage medium.

9. The monitoring system of claim 8, wherein the electrolyte is a solid electrolyte or a liquid electrolyte.

10. The monitoring system of claim 8, wherein the communication device is at least one a vehicle dashboard, a cellular telephone, and an internet-based communication system.

11. The monitoring system of claim 8, wherein the replaceable consumable electrode is configured to decrease in mass as the replaceable consumable electrode degrades.

12. The monitoring system of claim 8, further including a plurality of replaceable consumable electrodes each configured to degrade at different rates before the device corrodes.

13. A method of monitoring a corrosion of a plurality of joints of a device, the method comprising:
detecting a change in an electrical property of at least one of the plurality of joints with a monitor that is disposed in electrical communication with each pair of the plurality of joints, wherein detecting includes:
measuring an initial electrical property and a final electrical property between each pair of the plurality of joints; and
determining a difference between the initial electrical property and the final electrical property to thereby provide a computed electrical property;
comparing the computed electrical property to a threshold electrical property to provide an alert value;
after comparing, sending a first signal from the device to a storage medium; and
after sending the first signal, sending a second signal from the storage medium to a communication device to thereby monitor the corrosion.

14. The method of claim 13, wherein measuring the initial electrical property includes calculating:
an average initial resistance or an average initial capacitance; and
a standard deviation of the initial resistance or a standard deviation of the initial capacitance, respectively; and wherein measuring the final electrical property includes calculating:
an average final resistance or an average final capacitance; and
a standard deviation of the final resistance or a standard deviation of the final capacitance, respectively.

15. The method of claim 14, wherein determining includes calculating:
a first difference between the average final resistance and the average initial resistance; or
a second difference between the average final capacitance and the average initial capacitance, respectively; and
a first ratio between:
the first difference; and
a pooled standard deviation of the final resistance; or a second ratio between:
the second difference; and
a pooled standard deviation of the final capacitance.

16. The method of claim 13, wherein comparing includes identifying a location of the corrosion on the device.

17. The method of claim 13, wherein comparing includes recording the alert value in a reference two-dimensional array.

18. The method of claim 17, wherein recording includes color coding the reference two-dimensional array according to whether the corrosion is occurring at each of the plurality of joints.

19. The method of claim 13, further including forming at least one of the plurality of joints from dissimilar materials.

20. The method of claim 13, further including forming at least one of the plurality of joints by at least one of welding, adhering, melting, and mechanically fastening.
